(19) United States
(12) Patent Application Publication
(10) Pub. No.: US 2015/0147431 A1
(43) Pub. Date: May 28, 2015

(54) METHOD FOR SEXUAL ENHANCEMENT

(71) Applicant: Jennifer Rene SNOWDEN, Washington, DC (US)

(72) Inventor: Jennifer Rene SNOWDEN, Washington, DC (US)

(21) Appl. No.: 14/554,639

(22) Filed: Nov. 26, 2014

Related U.S. Application Data
(60) Provisional application No. 61/909,013, filed on Nov. 26, 2013.

(51) Int. Cl. A23L 1/00; A23L 1/236; A23L 1/27; A23L 1/30; A23L 1/05

(52) U.S. Cl. CPC A23L 1/0073; A23L 1/3014; A23L 1/05; A23L 1/27; A23L 1/236; A23V 2002/00
USPC 426/2; 426/61

(57) ABSTRACT

The invention relates to a method for sexual enhancement comprising placing a flavored dissolvable film strip, edible flavored gel or flavored edible spray in intimate contact with the vagina, clitoris, and/or perineum. The film strip, edible flavored gel or spray compositions contain a probiotic but do not contain any pharmaceutical ingredients.

The edible flavored dissolvable film strip comprises a flavoring agent, a probiotic, a dissolvable film forming agent and a sweetening agent. The addition of human mucosal secretions dissolves the film strip, thereby creating a flavor and probiotic enhanced mucosal environment.

The film strip, spray or gel compositions may also contain a coloring agent, a glow-in-the-dark agent, a tingling agent, an aroma enhancing agent.

### FIELD OF THE INVENTION

This invention relates generally to use of a sexual enhancement aid, and specifically to a method of sexual enhancement utilizing a flavored dissolvable film strip, gel or spray composition containing a probiotic culture. Because the experience of introducing a flavored probiotic film strip, gel or spray composition on mucosal body parts imparts a novel and pleasurable sensory experience (e.g., taste and smell) to the partner's mouth, the method of the present invention heightens the sexual experience. In addition, the beneficial probiotic component promotes a healthy vaginal flora and also advantageously provides beneficial probiotic cultures to the oral mucosa of the sexual partner.

### BACKGROUND OF THE INVENTION

It is common for individuals engaged in sexual activity to employ various sexual aids to enhance pleasure. Flavored lubricants and gels are often used to enhance sexual experiences by making oral contact with various body parts more enjoyable, particularly during oral-genital contact. These lubricants are often flavored or scented but may be messy and unpleasant to put into one's mouth. Probiotics help to maintain a normalized balanced vaginal flora population. Hence, a need exists to provide a fun sexual aid such as a flavored dissolvable probiotic containing film strip which is transformable into a sexually enhancing flavored mucosal environment and promotes a healthy vaginal flora. A need also exists to provide a fun sexual aid such as a flavored probiotic containing gel composition which promotes a sexually enhanced flavored mucosal environment and promotes a healthy vaginal flora population. A need also exists to provide a fun sexual aid such as a flavored probiotic containing spray composition which promotes a sexually enhanced flavored mucosal environment and promotes a healthy vaginal flora population.

### DESCRIPTION OF THE INVENTION

The flavored dissolvable film strip, gel or spray compositions used in the methods of the present invention are greaseless, non-staining, nonspermicidal, nonirritating, do not impede sperm motility and do not contain pharmaceutical ingredients. Since spermicidal agents and pharmaceutical agents could be transferred to the oral cavity of the sexual partner they are not appropriate for inclusion in the compositions used in the method of the present invention.

The film compositions used in the method of the present invention can be comprised of one or more layers. The components of the various layers may have different properties. For example they may dissolve at different rates and contain different flavors. One layer may contain flavoring and another layer may contain probiotic. However, in the aggregate, the film shall dissolve in that it will transition to fully dissolved parts that will be carried away by the normal cleaning processes of the mucosal tissue in question.

Dissolvable film strips are small, lightweight and can be carried discretely in one's wallet or purse. While the films strips used in the method of the present invention may be any shape or size (e.g., star, heart, flower, dot, strip), preferably they are sized for conventional film strip packaging containers. They may be stacked for multi-dose packaging or, if desired, be packaged in single dose form. The films of the invention can be packaged in a manner similar to the films and packaging containers used, for example, to make the Listerine PocketPak® mouth fresheners or Meltz Super Thin Mints®. Typically, the films are from 0.5 to 20 mm thick.

During use, the body heat and humidity in the contact area (e.g., vagina) engage the dissolvable polymer element and releases the flavoring agent, probiotic and other optional ingredients. Prior art gel lubricants are messy and sticky and are not conducive to application with significant periods of time before anticipated use. US 20090098188, the disclosure of which is incorporated herein, teaches the addition of nitrogen or other suitable gas to extend the dissolution time of a dissolvable film adapted for an internal body cavity. Thus, the dissolution properties of the dissolvable film of the present invention can be readily tuned and controlled for rapid dissolution (for example in 5-60 seconds) or for dissolution over prolonged periods (for example up 12-24 hours). Thus, for example, they can be applied to the vaginal mucosal area many hours before anticipated oral contact with a sexual partner. Alternatively, they can be applied as part of foreplay for rapid dissolution. The rate at which the polymer dissolves can be adjusted to allow sufficient internal resistance to flow so that the flavoring agent and probiotic remain on the portion of the body on which it has been placed, without readily flowing off due to gravitational effects.

An alternative embodiment of the present invention concerns a flavored gel or lotion and a method for sexual enhancement comprising placing a flavored gel or lotion in intimate contact with the vagina, external genitalia, clitoris, and/or perineum. The flavored gel is edible and comprises a flavoring agent, a probiotic and a sweetening agent. The gel does not contain pharmaceutical ingredients. The term “gel” as used herein means a semi-liquid and can be a cream, ointment, gel, lotion or foam. Preferably the gel has a pH close the natural pH of the vagina. The normal vaginal pH is 3.8 to 4.5. Thus, the pH of the gel composition may, according to an embodiment, be 3.5 to 4.5. The gel may also have lubrication properties.

An alternative embodiment of the present invention concerns a flavored spray composition and a method for sexual enhancement comprising spraying the flavored composition in intimate contact with the external genitalia, clitoris, and/or perineum. The flavored spray ingredients are edible and comprises a flavoring agent, a probiotic and a sweetening agent. The spray does not contain pharmaceutical ingredients. The term “spray ” as used herein means a liquid to semi-liquid composition that is capable of delivery via a spray nozzle delivery system. Preferably the spray has a pH close the natural pH of the vagina. The normal vaginal pH is 3.8 to 4.5. Thus, the pH of the spray composition may, according to an embodiment, be 3.5 to 4.5. The spray may also have lubrication properties.

Probiotic

The female vagina is naturally colonized by a variety of bacteria, yeast, and microorganisms. For example, a normal vagina generally contains more than about 10⁴ lactobacilli per milliliter of vaginal fluid. Under normal conditions, the vagina flora provides a mildly acidic environment that helps guard against the invasion of pathogenic microbes. Unfortunately, this vaginal balance may be easily upset by a variety of external factors that ultimately lead to vaginal infection. Vaginal infection is a clinical syndrome and exists in many forms, i.e., bacterial vaginosis and candidal vaginitis (“yeast”). Bacterial vaginosis, for example, is a polymicrobial vaginal infection believed to be caused by an increase in the number of anaerobic organisms with a concomitant decrease in lactobacilli in the vagina. The decrease in the number of lactobacilli in the vagina has the dual effect of decreasing competition for nutrients and decreasing the amount of lactic acid present (i.e., increasing the pH). This allows for the multiplication of opportunistic pathogens in the vagina, whose growth is normally suppressed by the lactobacilli and the acidic pH of the vagina. The principal pathogen associated with bacterial vaginosis is believed to be Gardnerella vaginalis. See, for example, U.S. Pat. No. 7,786,176.

Components of sexual enhancement gels and strips contain ingredients which in some cases can act as nutrients for bacteria. Cellulose, starches, sweeteners, glycerin and propylene glycol may act as nutrients for bacteria and thus residual amounts may negatively affect the natural flora balance of the vagina. The presence of preservatives may also negatively. affect the natural balance the flora of the vagina Thus, the addition of beneficial probiotics to the compositions of the present invention helps to address the potential overgrowth of certain microorganisms such as Gardnerella vaginalis which in some cases may result from residual components in the gel or strip compositions.

Probiotics are live microorganisms which when administered in adequate amounts confer a health benefit to the host. See, for example, J. Antimicrob. Chemother. (2006)58 (2): 266-272. In the present invention the probiotic component helps to normalize the healthy vaginal flora and is believed to help prevent yeast infections and Bacterial Vaginosis. Candida albicans is opportunistic yeast that normally inhabits the mouth, throat, intestines and genitourinary tract. It is part of the normal flora that coexists in the human body. However, it may become pathogenic when there is a disturbance in the balance of flora. Sexual intercourse, deep kissing and oral sex can transmit Candida to/from the genitals or mouth from one person to another. If one partners immune system is impaired or he/she consumes a high sugar or carbohydrate diet then Candida can over proliferate causing Vulvovaginal candidiasis (VVC) which is a common infection affecting the quality of life of many women. Bacterial Vaginosis is another common vaginal infection, which is caused by an imbalance of naturally occurring vaginal bacteria. This maybe brought on by overuse of antibiotics, feminine hygiene products, and even stress. Probiotics have been investigated as possible agents for the prevention of recurrences of both VVC and Bacterial Vaginosis. See, for example, Monteleone G, Peluso I, Tina D, et al. Bacteria and rnucosal immunity. Dig Liver Dis. 2006 December;38(Suppl 2):S256-60. Thus, the film strip of the present invention provides friendly normal flora to mucosal areas of both partners.

Preferred Probiotic cultures for the gels or dissolvable film strip used in the present invention include, but are not limited to, one or more of the following: Lactobacilli, especially Lactobacillus crispatus, Lactobacillus jensenii and Lactobacillus iners (which are the dominant microorganisms in the vagina of healthy premenopausal women). Other preferred probiotic organisms include Lactobacillus rhamnosus (GR-1), Lactobacillus reuteri (RC-14), Lactobacillus Casei, Lactobacillus Plantarum, Lactobacillus Acidophilus, Bifidobacterium Bifidum, Bifidobacterium Longum, Lactobacillus Salivarius, Lactobacillus Brevis, Lactobacillus gasseri and/or Lactobacillus Bulgaricus. The probiotic mixture may be microencapsulated and incorporated into the mixture as microparticles. Preferably the film strips of the present invention contain between 1-60 billion live cells (CFU), preferably between 2-30 billion live cells and most preferably between 3 and 20 billion live cells.

Preferably the probiotics are microencapsulated to protect the viability of the live cells. There are numerous conventional microencapsulation methods known to one skilled in the art. See, for example, U.S. Pat. No. 8,168,225 which teaches a continuous micro-encapsulation water-in-oil-in-water microencapsulation process through in situ and interfacial polymerization of the emulsion. The microcapsules are particularly appropriate for incorporation into a spray or gel composition. The disclosure is incorporated herein by reference. US20130084271, US20080102132; WO2012098239; CA2825011 or US20090238890 also provide useful and efficient manufacturing methods for the stabilization of probiotic bacteria prior to their introduction into functional foods . US20050042207 provides guidance on preparation of a liquid composition containing probiotic bacteria. The disclosures are incorporated herein by reference. Microcapsules which dissolve or melt at body temperature and vaginal pH are most preferred.

Film Forming Polymer

The dissolvable film forming polymers used are typically polysaccharide-based or polysaccharide and glycoprotein-based gums such as pullulan, pectin, locust bean gum, gelatin, xanthan gum, sodium alginate, gum Arabic and the like. One or more of these can be used in the current films, though generally the overall content of polymer that swell or dissolve more slowly may be higher or lower depending on the desired end use. Other potential water-soluble polymers include, for example, polythylene oxide, hydrosypropyl methylcellulose, methylcellulose, carboxymethylcellulose and polyvinyl pyrrolidone. The dissolvable polymer material is preferably a food-grade material safe for internal use. Preferably, the dissolvable element is chosen to be heat stable (e.g., up to 140° F.), and humidity stable (e.g., up to 99% relative humidity) so as to remain in substantially solid form and not begin dissolving before its intended use.

Most preferably, the film forming agent used in the dissolvable films according to the present invention can be, for example, pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein and mixtures thereof. A preferred film former is present in amounts ranging from about 0.01 to about 99 wt %, preferably about 30 to about 80 wt % (e.g., 35, 40, 45, 50, 55, 60, 65, 70, 75 wt %), more preferably from about 45 to about 70 wt % of the film and even more preferably from about 60 to about 65 wt % of the film.

Dissolvable polymers are polymers which, in the aggregate, dissolve completely or sufficiently so that any residual polymer is readily suspended in mucosal fluids. The polymer is selected such that the film melts, dissolves, or dissipates in the environment of the cavity (e.g., vagina) to release the flavoring agent and probiotic component into and/or around the cavity. The amount of polymer can vary depending on the desired mucosal residence time. The mucosal residence time is the time it takes a film to dissolve when placed on an appropriate mucosal surface (which may depend on the target site for the film's use), assuming no directed mechanical action, such as with a user's tongue.

The polymers can be polymers that affect the rate of hydration or mucosal adhesion properties. Such polymers can be, for example, carboboxymethylcellulose, cellulose acetate, ethylcellulose, hydroxyethylcellulose, hydroxypropylmethylcellulose (HPMC, such as Pharmacoat 606™, Shin-Etsu Chemical Company Ltd., Japan), nitrocellulose, polyoxyethylene/polyoxypropylene polymers, copolymers or block copolymers, polyvinylpyrrolidone polymers or derivatives, gums such as described above, and the like. Average molecular weight can be selected based on the swelling and dissolution profile sought. Mixtures of less soluble and/or less swellable polymers with more soluble or swellable polymers can help transition the film to a sufficiently dissolved form.

In certain embodiment's non-biodegradable thickeners or film formers, such as, for example, polymers of cross-linked polyacrylate are preferred in place of cellulose or starch based thickeners or film formers.

Flavoring Agent

The flavoring agent used in the gels or film strip may be a natural or artificial flavoring. A natural flavor may be an essential oil, oleoresin, essence or extractive, mineral, protein hydrolysate, distillate, or any product of roasting, heating or enzymolysis, which contains the flavoring constituents derived from a spice, fruit or fruit juice, vegetable or vegetable juice, herb, bark, bud, root, leaf or similar plant.

The flavoring agents may include, for example, individual flavors or combination of two or more flavors. Exemplary natural and artificial flavorants include, but are not limited to, peppermint, spearmint, wintergreen, menthol, cinnamon, chocolate, vanillin, licorice, clove, anise, sandalwood, geranium, rose oil, vanilla, lemon oil, cassia, fennel, ginger, ethylacetate, isoamylacetate, propylisobutyrate, isobutylbutyrate, ethylbutyrate, ethylvalerate, benzylformate, limonene, cymene, pinene, linalool, geraniol, citronellol, citral, orange oil, coriander oil, borneol, Almond, Amaretto, Apple, Apricot, Banana, Banana Cream, Bavarian Cream, Blackberry, Black Cherry, Blueberry, Boysenberry, Brandy, Bubblegum, Butter, Butterscotch, Caramel, Caramel Apple, Champagne, Cheesecake, Cherry, Cherry Vanilla, Chocolate, Chocolate Mint, Cinnamon, Citrus Punch, Clove, Coconut, coffee, Cola, Cookies and Cream, Cotton Candy, Cranberry, Dragonfruit, English Toffee, Fig, French Vanilla, Fruit Punch, Ginger, Gingerbread, Grape, Grapefruit, Guava, Hazelnut, Honey, Honeysuckle, Irish Cream, Juicy Fruit, Key Lime, Kiwi, Kiwi Lime, Kona, Lavender, Lemon, Lemondrop, Lime, Macadamia, Mandarin Orange, Mango, Maple, Melon, Mint, Mocha, Nutmeg, Orange, Papaya, Passionfruit, Peach, Peanut Butter, Pear, Pecan, Pina Colada, Pineapple, Pistachio, Plum, Praline, Pomegranate, Raspberry, Raspberry Truffle, Root Beer, Rum, Salsa, Sour Apple, Spice, Strawberry, Strawberry Cheesecake, Strawberry Kiwi, Tabasco, Tangerine, Tequila, Tropical Fruit, Vanilla, Watermelon, or any combination of the foregoing with other natural or artificial flavors. The flavoring agent can be added to the film strip composition in encapsulated or non-encapsulated form.

Other Components

Sweetening agent(s), filling agents, plasticizers, penetration enhancers, vitamins, preservatives, color enhancing agent(s), aroma enhancing agent(s), glow-in-the-dark agent(s), organic glitter, tingling agent(s) , emulsifiers and the like can be included in the spray, film or gel compositions.

The spray, gel or dissolvable film strips used in the method of the present invention may optionally comprise both natural and artificial sweeteners. In general, the effective amount of sweetener is the amount which provides the level of sweetness desired for a particular composition, and this amount will vary with the sweetener selected. This amount will normally be 0.01% to about 10%, preferably in amounts of about 2 to about 5% by weight of the composition. These amounts may be used to achieve a desired level of sweetness independent from the flavor level achieved from any flavoring agent. Suitable sweeteners include water soluble sweeteners such as monosaccharides, disaccharides and polysaccharides (e.g., xylose, ribose, sucrose, maltose, fructose, glucose, maltose, mannose). The composition preferably comprise a sweetener such as Luo Han Guo, xylitol, agave nectar, isomalt, mannitol, maltitol, sorbital, stevia, honey, sucralose, sucrose, aspartame, acesulfame K, saccharin, brazzein, stevioside, aspartame, or other polyol with similar capacity to impart a sweet taste when the film strip ingredients contacts a person's tongue, and the capacity to stimulate enhanced production and saliva flow from salivary glands when the sweetener is taken into a person's mouth. In addition, or in the alternative to sweeteners, the exemplary film strip can comprise souring agents such as acetic acid, adipic acid, citric acid, lactic acid, malic acid, succinic acid, tartaric acid, and mixtures thereof. The sweetener may also comprise a food grade acid such as, ascorbic acid or citric acid, and a sweetener taken from the above list.

Plasticizers will generally modify the feel, softness, flexibility (in an un-wetted state) of the film. Suitable plasticizers include, for example, glycerin, propylene glycol, fatty acid esters (such as glyceryl oleate) and/or polyethylene glycol.

Penetration enhancers may, in some cases, act as plasticizers. Examples of penetration enhancers include, for example, PEG[C10-C30]alkyl, N-lauroyl sacrcosine, sorbitan monolaurate, stearyl methacrylate, N-Dodecylazacycloheptan-2-one, N-dodecyl-2-pyrrolidinone, N-dodecyl-2-piperidinone, 2-(1-nonyl)-1,3-dioxolane, N-(2-methoxymethyl) dodecylamine, N-dodecylethanolamine, N-dodecyl-N-(2-methoxymethyl)acetamide, 1-N-dodecyl-2-pyrrolidone-5-carboxylic acid, 2-pentyl-2-oxo-pyrrolidineacetic acid, 2-dodecyl-2-oxo-1-pyrrolidineacetic acid, 2-dodecyl-2-oxo-l-pyrrolidineacetic acid, 1-azacylioheptan-2-one-dodecylacetic acid, and the like.

Pigments (e.g., coloring enhancing agents) may be included in an amount sufficient to impart a desired color or color pattern to the spray, gel or film strips. Coloring agents can be incorporated into the mixture of components used to form the film and/or coloring agents can be applied to (e.g., printed on) one or more surfaces of the dissolvable film strip. Fun or romantic phrases or logos can be printed on the film strips. Coloring agents can be incorporated into the film strip in an effective amount up to about 5 wt. % of the final, dried film composition, more preferably up to about 2 wt. % and most preferably up to about 1 wt. %. The color enhancing agent may be a powdered food dye, a dispersion coloring agent such as a powdered aluminum or other metallic lake, natural colorings derived from natural sources such as but not limited to, annatto extract, beta-carotene, grape skin extract, cochineal extract or carmine, paprika oleoresin, caramel color, fruit and vegetable juices, saffron, etc., and the like, including any combination of the foregoing. Coloring agents may also comprise food substances that are colored powders such as powdered beverage mixes, baking coloring agents, and the like, or any combination of the foregoing.

Certain embodiments of the spray, gel or film strip compositions may optionally comprise a powdered, food-grade glow-in-the-dark agent exhibiting either phosphorescence, fluorescence, ultraviolet reactivity and the like which may increase pleasure in a sexual experience by adding a visually observable stimulus where the dissolvable film strip or gel either glows phosphorescently or under the influence of a source of ultraviolet light, such as a black light.

Certain embodiments of the spray, gel or film strip composition may also contain pH adjusting agents such as ascorbic acid, vitamin C and the like. Any pH adjusting agent that is food grade is acceptable. The optional pH adjusting component helps to adjust the pH of the vaginal cavity.

Certain embodiments of the spray, gel or film strip composition may optionally comprise a preserving agent such as but not limited to a preservative such as sodium benzoate, calcium propionate, sodium erythorbate, sodium nitrite, calcium sorbate, sodium sorbate, potassium sorbate, BHA, BHT, EDTA, erythorbic acid, sodium diacetate, sodium succinate, grape seed extract, pine bark extract, apple extract, tea propylphenols, succinic acid, paraben, sodium dehydroacetate or tocopherols or any combination of the foregoing.

Filling agents can be used to control the films physical properties (e.g., texture, weight, etc.). Exemplary filling agents include, but are not limited to, cellulose, titanium oxide, magnesium silicate (e.g., talc), aluminum silicate, magnesium carbonate, calcium carbonate (e.g., limestone), calcium phosphate, calcium sulfate, zinc oxide, aluminum oxide, and mixtures thereof.

The spray, gel or film strips may also contain a vitamin ingredient (e.g. vitamin A, C, E, D or B 12) and a tingling (warming) ingredient (e.g. menthol or L-arginine ethyl ester).

Because natural flavoring is often accomplished by using molecules that exhibit some degree of volatility and can be detected by the olfactory system, the flavoring agent may also act as an aroma enhancing agent. Particularly preferred additional flavor and aroma agents are essential oils and essences of coffee, tea, cacao, and mint. For example, although a natural peppermint flavor may be added to enhance taste, it is apparent to those skilled in the art that the addition of peppermint flavoring agent will produce a desirable aroma. It should be obvious to one skilled in the art that peppermint flavoring agent is used here as an example of the aroma enhancing properties of a flavoring agent, and the use of a flavoring agent as an aroma enhancing agent is not limited to peppermint flavoring agent. Flavoring agents which also act as warming or tingling agents are particularly preferred. Aroma agents that do not contribute to the flavoring profile may also be used.

In certain embodiments of the invention the gel or dissolvable strip may comprise a thickening agent such as, for example, lecithin derived from soy or egg sources, corn starch, potato starch, fecula, arrow root, katakuri starch, sago, tapioca, collagen, furcellerum, carageenan, algar, alginate, guar gum, locust bean gum, xanthan gum, a mixed ester of glycerol and choline, mono- and di-glycerides of fatty acids and their esters, phosphated monoglycerides, or other food grade phospholipids.

A skilled worker would recognize that numerous methods of forming the dissolvable film strips are readily available. Preferably, the dissolvable film strips can be made by casting or extruding a liquid mixture comprising one or more flavoring agents, one or more film forming polymers, one or more sweeteners, and one or more probiotics and then drying the cast or extruded film. Alternatively, the probiotic can be added after the film strip has been cast or extruded. The film strips can be made by casting. A method of casting film strips comprises forming a homogeneous mixture (or slurry) of the ingredients and casting the mixture to form a film, drying the film and cutting the film into strips. Other suitable methods of making a base film formulation are disclosed, for example, in U.S. Pat. No. 7,946,296; U.S. Pat. No. 5,529,782; U.S. Pat. No. 8,540,980; W003030882 and U.S. Pat. No. 5,380,529, which are incorporated herein by reference. Often the film is formed using a pharmaceutically appropriate solvent such as ethanol, water, mixtures, or the like. However, such solvents are typically substantially evaporated away prior to use and do not remain in the film strip when administered.

The following Examples are illustrative of various embodiments of the dissolvable probiotic containing flavored film strip used in the method of the present invention, as described herein, however, the scope of the invention is not intended to be limited by the specific details of the examples.

### EXAMPLE 1

### Film Strip

Peppermint oil [flavoring agent],
Gum Arabic [ stabilizer/film former],
Sucralose [Sweetener]
Pullulan [water soluble polymer]
Glycerin [sweetener/Plasticizer],
Polysorbate 80 [emulsifier]
Ascorbic acid [pH controlling agent]
10⁹ CFU Lactobacillus rhamnosus and
10^{̂9}CFU Lactobacillus gasseri.

### EXAMPLE 2

### Film Strip

| | |
|---|---|
| Cherry Flavoring | 3% |
| Hydroxypropylmethyl cellulose [film former] | 53% |
| Glycerin [sweetener/Plasticizer] | 29% |
| Menthol [tingling agent] | 2% |
| Gum Arabic [stabilizer/film former] | 4% |
| Sucralose [Sweetener] | 3% |
| Polyvinyl alcohol [water soluble polymer] | 3% |
| Tween 80 [emulsifier] | 2% |

microencapsulated Probiotics to balance:
10⁹ CFU Lactobacillus rhamnosus and
10^{̂9} CFU Lactobacillus gasseri

### EXAMPLE 3

### Gel Composition

| Water | 90-98 wt % |
|---|---|
| cross-linked polyacrylate | 0.01-3% |
| poly(ethylene oxide) polymer | 0.01-2 wt % |
| Splenda ® | .05-3% |
| Chocolate Flavoring | 1-3% |

̂microencapsulated Probiotics to balance:
̂10⁹ CFU Lactobacillus rhamnosus and
̂10^{̂9} CFU Lactobacillus gasseri

Numerous variations are of course possible in the light of principles and examples disclosed above. All such variations are intended to be included within the entire spirit and scope of invention, as defined in the following claims.

1. A method for sexual enhancement comprising:
placing a flavored dissolvable film strip in intimate contact with the vagina, clitoris, and/or perineum,
wherein said flavored dissolvable film strip is edible and comprises
a flavoring agent,
a probiotic,
a dissolvable film forming agent,
and
a sweetening agent
wherein said film strip does not contain pharmaceutical ingredients and
wherein the addition of human mucosal secretions dissolves the film strip, thereby creating a flavor and probiotic enhanced mucosal environment.

2. The method of claim 1, wherein said film strip further comprises a coloring agent.

3. The method of claim 1, wherein said film strip further comprises a glow-in-the-dark agent.

4. The method of claim 1, wherein said film strip further comprises a tingling agent.

5. The method of claim 1, wherein said film strip further comprises an aroma enhancing agent.

6. An edible dissolvable film strip for vaginal delivery of a flavoring and probiotic comprising:
a flavoring agent,
a probiotic,
a dissolvable film forming agent,
and
optionally a sweetening agent
wherein said film strip does not contain a pharmaceutical ingredient and
wherein the film strip is dissolvable in contact with human vagina, clitoris, and/or perineum secretions, thereby creating a flavored and probiotic enhanced mucosal environment.

7. The edible dissolvable film strip of claim 6, wherein said film strip further comprises a coloring agent.

8. The edible dissolvable film strip of claim 6, wherein said film strip further comprises a glow-in-the-dark agent.

9. The edible dissolvable film strip of claim 6, wherein said film strip further comprises a tingling agent.

10. The edible dissolvable film strip of claim 6, wherein said film strip further comprises an aroma enhancing agent.

11. A method for sexual enhancement comprising:
placing an edible flavored gel in intimate contact with the vagina, clitoris, and/or perineum,
wherein said flavored gel is edible and comprises
a flavoring agent,
a probiotic,
and
a sweetening agent
wherein said gel does not contain pharmaceutical ingredients.

12. The method of claim 11, wherein said gel further comprises a coloring agent.

13. The method of claim 11, wherein said gel further comprises a glow-in-the-dark agent.

14. The method of claim 11, wherein said gel further comprises a tingling agent.

15. The method of claim 11, wherein said gel further comprises an aroma enhancing agent.

16. A method for sexual enhancement comprising :
spraying an edible flavored spray composition in intimate contact with the external genitalia, clitoris, and/or perineum,
wherein said spray composition is edible and comprises
a flavoring agent,
a probiotic,
and
a sweetening agent
wherein said spray composition does not contain pharmaceutical ingredients.

17. The method of claim 16, wherein said gel further comprises a coloring agent.

18. The method of claim 16, wherein said gel further comprises a glow-in-the-dark agent.

19. The method of claim 16, wherein said gel further comprises a tingling agent.

20. The method of claim 16, wherein said gel further comprises an aroma enhancing agent.
